(19) United States
(12) Patent Application Publication
(10) Pub. No.: US 2008/0039268 A1
(43) Pub. Date: Feb. 14, 2008

(54) Ball Gearings for Rotation Transfer

(76) Inventors: Viktor V. Stanovskoy, Tomsk (RU); Sergei M. Kazakiavichius, Tomsk (RU); Tatiana A. Remneva, Tomsk (RU)

Correspondence Address: MOETTELI & ASSOCIATES SARL, ST. LEONHARDSTRASSE 4, ST. GALLEN, CH-9000, omitted

(21) Appl. No.: 11/568,398

(22) PCT Filed: Apr. 25, 2005
(86) PCT No.: PCT/RU05/00220

§ 371 Date: Jun. 25, 2007

(30) Foreign Application Priority Data
Apr. 27, 2004 (RU) 2004113046

(51) Int. Cl. F16H 13/00

(52) U.S. Cl. 476/36

(57) ABSTRACT

The inventive rotation transmitting ball gear is used for increasing performance and reliability of any speed transducers in which a torque is transmitted by balls gearing with periodic grooves of links. Said invention makes it possible to improve the distribution of interaction forces between the ball and the walls of the periodic grooves and to shift the ball contact area from the groove sidewall to the bottom thereof. For this purpose, said ball gear, as a prototype, comprises elements provided with grooves on the surface thereof oriented to each other and a chain of balls simultaneously gearing with the grooves of all links, wherein the integrated amplitude of the periodic grooves of an interacting pair is equal to or less than the ball diameter. Contrary to the prototype, the element surfaces which are provided with grooves, oriented to each other and act on the ball by the sidewalls thereof, are mutually stepwisely interfaced to each other, the grooves are embodied in said mutually stepped surfaces and are adjacent to each other in such a way that the height of the sidewall of each groove is increased in an area and is greater than the ball radius by reducing the height of the groove sidewalls on the area opposite thereto of the other links. The increased height of the opposite groove sidewalls shifts the contact points of the ball with the groove walls in such a way that acting and reacting forces produced by the grooves on the ball lie along the same straight line and have only one component carrying out a useful work.

### FIELD OF THE INVENTION

The present invention relates to the mechanisms for rotation transfer. More specifically, the invention set forth arrangement for rotation transfer using a chain of balls engaging periodic elements on surfaces of cooperating parts. Such devices are actively developed now as can be used in drives of all-purpose machines and mechanisms. Transmitting units with ball engagements bear marks of enhanced load-bearing ability and reliability. They are simpler and decreased in dimensions in comparison to tooth gearings for equivalent loadings and gear ratios.

### BACKGROUND OF THE INVENTION

Known ball gearings can be subdivided into gearings in which the ball cooperates with periodic elements provided in three and more parts (U.S. Pat. No. 5,016,487, U.S. Pat. No. 4,960,003, RU2179272); or with periodic elements of two parts (U.S. Pat. No. 4,829,851, U.S. Pat. No. 4,643,047, RU2179672). Ball engagement with two parts is used in transfers where one of parts makes planetary moving (U.S. Pat. No. 4,829,851, U.S. Pat. No. 4,643,047), or in transfers with parallel shafts (RU2179672). In transfers with ball engagements, the guide grooves on surfaces of cooperating parts represent periodic grooves of corresponding cross sections and the various forms. In these cases, the “guide groove” is a recession with its cross-section coinciding with the form of a ball, or through slot with the width equal to diameter of a ball, Le., in a general way, it is either extended equiangularly spaced flutes (RU2179272, SU 1260604), through slots (SU1399548, SU1569470, U.S. Pat. No. 5,312,306), hemispherical (RU2179672) or toroidal (U.S. Pat. No. 4,829,851) dimples, or closed periodically bent grooves with generating lines in the forms of trochoidal curve, cycloidal curve, sinusoids or a circle, etc. (M. F. Pashkevich [symbol] Vestnik mashinostroyenija, No. 7, 1985). Said periodic guide grooves (periodic surface elements) may mate to each other in various combinations depending on purpose and features of a transfer design.

As a prototype we choose a face-mounted ball engagement of “three-sinusoidal” ball gear (R. M. Ignatishchev, “Vestnik mashinostroyenija” No. 2, 1987 p). In this gear, closed periodically bent grooves are made in extreme disk parts; the intermediate part is made with equiangularly spaced slots. In such device, to keep contact of a ball with all grooves, the depth of the periodic grooves cannot exceed ⅓ of a ball diameter. At all advantages of ball transfers, above requirement essentially influences forces distribution when torque is transmitted, to worsen this distribution. FIG. 1 shows force distribution in such gearing, where F is the force acting a ball from the drive part, N is reaction force of a driven part. Forces F and N are applied to walls edges of the grooves 3 and 4, and each said forces have two components: F₁, F₂ and N₁, N₂, respectively. Forces F₁ and N₁ are useful forces, and force N₂ operates in an axial direction to push apart the driving parts 1 and 2 from each other, thereby causing a disengagement ball with grooves. And, certainly, this component N₂ increases friction and reduces transfer efficiency. Further, a ball affects to edges of walls 3 and 4, thereby increasing the probability of their destruction.

Accordingly, it is a principal object of the invention to provide a ball gearing with increasing both an efficiency and reliability, and especially, it is when high torque is transmitted. The technical result of the invention is improvement of forces distribution in interaction of a ball and grooves walls, and other result is displacement of a ball contact area from wall edge toward its bottom.

### SUMMARY OF THE INVENTION

Ball engagement accordingly to the invention, as well as the prototype, comprises, a number of parts provided with periodic grooves in faced each other surfaces of said parts; and a chain of balls simultaneously engaging the grooves of all parts, wherein ball engagement the sum amplitude of the periodic interacting grooves is no more than the ball diameter. Unlike the prototype, faced each other surfaces of parts which surfaces having grooves actuating by their side walls to a ball are made mutually stepped meeting, and said grooves are cut in these stepped meeting surfaces, and said groves are so conjugate each other that the height of one sidewall of each groove is increased to exceed the ball radius by means of reducing of opposite thereto groove sidewalls of the other parts. Due to the increased height of the groove sidewalls the point of a ball contact with the sidewall is so shifted that forces acting ball from this sidewall lie along the same straight line thereby having only single component performing useful effect. The invention is applicable to any kind of ball gearing and to any known forms of the conjugated grooves. It can be gearing of a ball with two parts, or with three and more. Grooves can be executed either in flat surfaces of disks (flat ball gearing), or in cylindrical or spherical surfaces. Grooves can be bent either in axial or in radial directions and accordingly to cause periodic movement of a ball.

Further, the invention is explained in conjunction with the accompanying drawings wherein interaction of a ball with different types of periodic grooves in conjugated gearing parts is shown.

### BRIEF DESCRIPTION OF THE DRAWINGS

FIGS. 1 and 2 are schematic, sectional views of a ball engagement with two disc parts;

FIGS. 3 and 4 show schematic views of periodical grooves in all parts of gearing in FIG. 2;

FIG. 5 shows a section through the two-part disc gear having toroid dimples in one of parts;

FIGS. 6 and 7 show view of periodical grooves in parts of gearing in FIG. 5;

FIG. 8 shows a section through the two-part disc gear having conjugated cycloid groove and semispherical dimples;

FIGS. 9 and 10 show view of periodical grooves in parts of gearing in FIG. 8;

FIG. 11 illustrates a variant of three-part ball gearing;

FIG. 12 depicts the part with spaced radial slots of gearing in FIG. 11;

FIG. 13 illustrates a second embodiment of three-part gearing;

FIG. 14 is an exploded detail view of the ball gearing shown in FIG. 13;

FIG. 15 shows view of partially cut one part of the ball gearing in FIG. 13;

FIGS. 16 and 17 illustrate a third embodiment of three-part ball gearing, sectional view and exploded detailed view, accordingly,

FIG. 18 shows a section one of embodiments of cylindrical gearing with axial movement of balls.

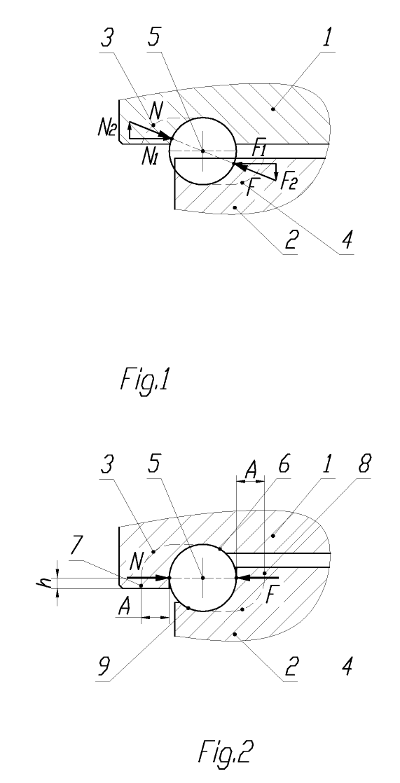

### DESCRIPTION OF THE PREFERRED EMBODIMENT

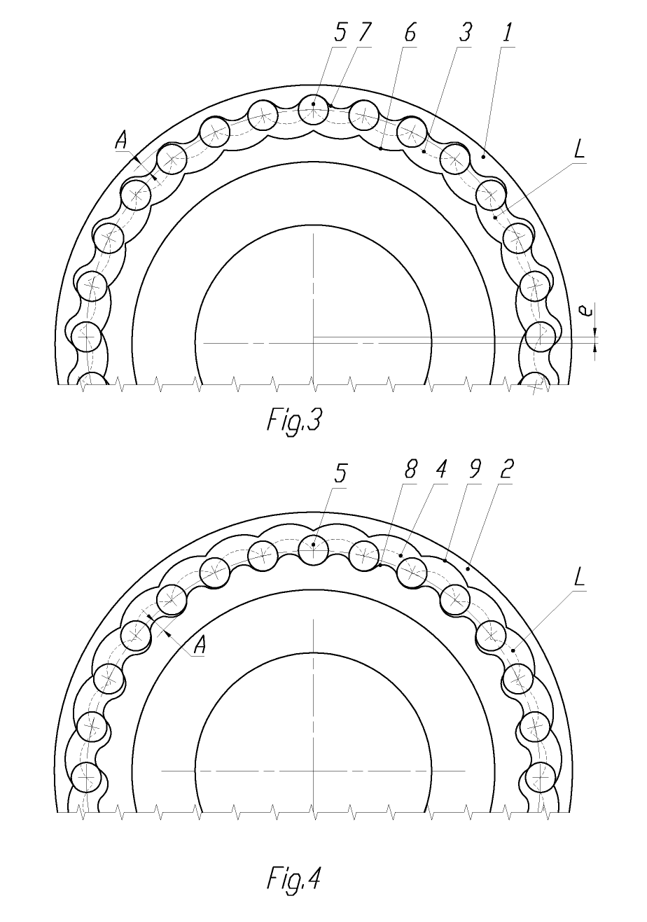

Referring now to the drawings wherein corresponding parts are identified by the same reference numeral. A flat ball gearing shown in FIGS. 2, 3, 4 composed of disk parts 1 and 2 in surfaces of which periodic grooves 3 and 4 are made in the form of closed periodically bent ball races with different number of the periods and identical amplitudes A. Basically, amplitudes of said grooves can be different, this condition does not limit a scope of the invention. At points of intersecting of grooves 3 and 4 there are placed balls 5 contacting with walls of both said grooves. Each closed groove has two side walls. The edges of these grooves have the form of curves equidistantly shifted inside and outside from the central line L of a periodic path. These walls are 6 and 7 in groove 3, and walls 8 and 9 in the groove 4 (FIGS. 3 and 4). It should be noted that forms of these curves are different from each other, and also from the form of the central line L that is well shown in FIGS. 3 and 4. The difference is most significant when balls are of large diameter, or when a number of the periods is big, or when there is low amplitude of oscillation (these are conditions of high load transfer). An undercutting of a groove also increases this difference. Thus, in ball gearing for high load transfers, the opposite walls of multi-periodical grooves have, as a rule, the different angles of rise. Loading is transferred basically by means of wall with a high angle of rise, and the opposite wall only fixes each ball in the certain position and returns ball in the necessary position during a nonworking part of a cycle. In the disk 1, this loaded (working) wall is a wall 7, and in the disk, 2 this loaded wall is a wall 8. Opposite walls 6 and 9 are non-working; their height can be reduced, as because of effect of undercutting these walls contact to balls not by lines 6 and 9, but by sites located more deeply. Non-working walls 6 and 9 only fix position of each ball in gearing. Such gearing is used mainly in high-speed transfers. At high speeds of rotation there are significant centrifugal forces acting to balls 5 can disturb movement of a ball, if ball has not fixed position in space. Therefore, it is impossible to cut off the non-working walls 6 and 9 entirely in the gearing, as for them is very important the function of return balls during a non-working part of transfer cycle.

Disposing of a wall with higher rise angle depends on embodiment of the ball gearing. For cycloid grooves the following rule is fairly. If the number of periods in a groove is more than number of balls then rise angle of external wall 7 is higher than rise angle of an internal wall 6, and wall 7 is more loaded. FIG. 3 illustrates this rule, where the number of balls is 28 a groove 3 has 29 periods. For improvement of forces distribution in gearing, the external wall 7 has its height exceeding radius of a ball by certain value h (see FIG. 2). So that the ball has not left contact to walls of both grooves 3 and 4, a wall 9 in the groove 4, which wall is opposite to the increased wall 7 in the groove 3, is made with the height reduced by value h. Accordingly, a groove 4 with number of the periods 27 has internal wall 8 as working wall which is made with increased height by reduction height of opposite to it wall 6 of a groove 3. For realization of above in practice, the conjugating faced each other surfaces having said grooves are made mutually stepped meeting in the areas of grooves accommodation, and said grooves are cut in these stepped meeting surfaces. As parts 1 and 2 should have an opportunity to rotate relative to each other, such change of walls height is possible only for grooves of which total amplitude does not exceed a ball diameter. Only in this case during rotation of parts relative to each other there walls with the increased height are opposite to walls with reduced height, and are not hooked with each other. [symbol] r 2 shows the distribution of the forces acting to both walls of groove and to a ball. It is seen that these forces F and N have only radial components which are in value larger of corresponding force components in the prototype. Absence another components of these forces reduces friction in gearing and remotes the necessity in additional spring-loading of disks 1 and 2 to each other. Furthermore, the area of a ball contact with a groove's wall is displaced from its edge, thereby reducing probability of its destruction.

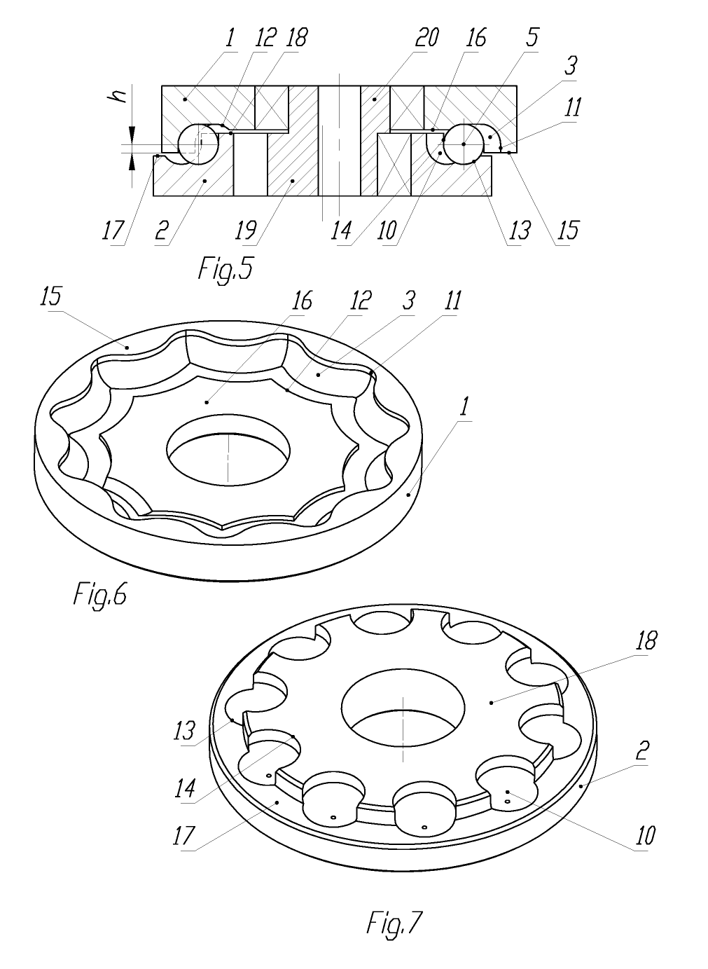

In other embodiment shown in FIG. 5, the ball gearing is formed by the closed periodic groove 3 conjugated with toroid dimples 10. Each of dimples 10 is formed by rotating a circle having radius equal to a ball radius. Such gearing is intended for transmitting unit consisting of two disk parts 1 and 2, periodic grooves of which are shown in FIGS. 6 and 7. Side walls of the closed groove 3 are designated by 11 and 12. The height of side wall 11 exceeds the radius of a ball 5 by a value h; accordingly, the height of dimples walls 10 is reduced by the same value h in opposite area 13 of a disk 2. Walls height of dimples 10 in the area 14 laying opposite to the area 13 is increased accuracy to the value h. For maintenance of contact of a ball 5 with both grooves 3 and 4 the height of a wall 12 is reduced in the groove 3. The surface of a disk 1 is formed by steps 15 and 16 at the joint of which there is cut the groove 3. The surface of a disk 2 also is formed by steps 17, 18 but these steps in comparison with a disk 1 have exchanged places, i.e. surfaces of disks 1 and 2 are in steps mated each other. All the above-stated explaining away force distribution, and away increasing of durability, is fair for this gearing also. In the gearing, said disk 2 is mounted at the eccentric 19 of an input shaft 20. Said disk 1 is aligned with an axis of the input shaft 20 by means of bearing. The disk 2 makes parallel-plane orbital motion relative to the disk 1, and both the disk 1 and the disk 2 have an opportunity to rotate around of their own axes. If one of disks, for example a disk 1, is sopped from rotation, the other disk rotates around own movable axis with certain transfer ratio.

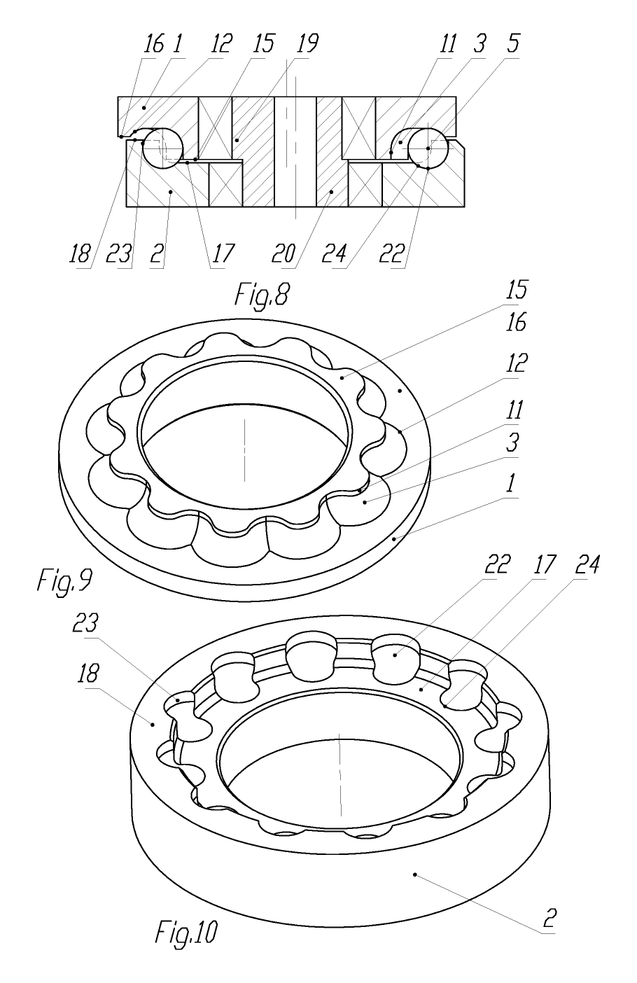

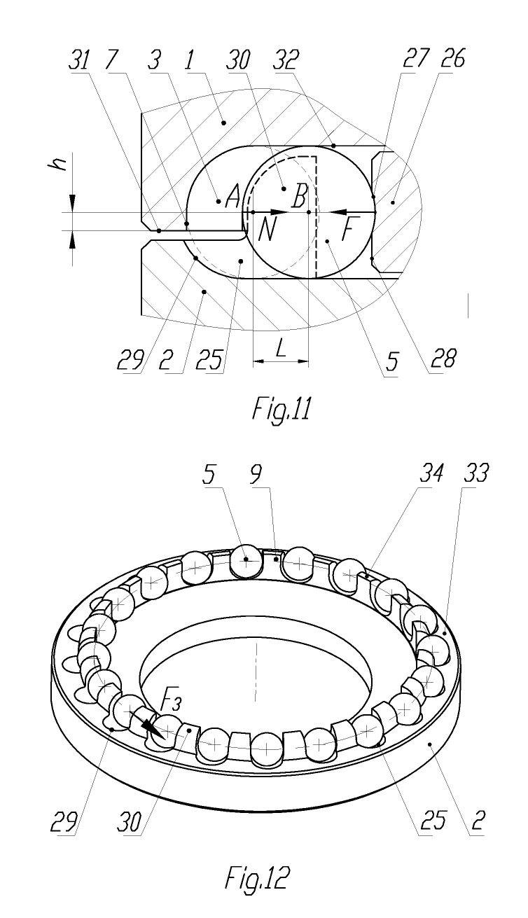

FIG. 8 shows example of the ball gearing wherein the closed periodic groove 3 conjugates with hemispherical dimples 22. Said groove 3 and hemispherical dimples 22 are made in surfaces faced to each other of both disk parts 1 and 2. FIGS. 9 and 10 show disks 1 and 2 with their periodical members. In this gearing, the wall 11 of the periodic groove 3 has the height exceeding a ball radius. The part of a wall 23 of the hemispherical dimple 22 has the height exceeding a ball radius. Accordingly, sites of groove 3 and dimple 22, laying opposite of increased walls, have reduced by the same value walls height. They are a wall 12 of the groove 3 and a part 24 wall of a dimple 22. Faced to each other surfaces of disks 1 and 2 are made stepped, and steps 15 and 16 of one disk are mated steps 17 and 18 of another disk. In the gearing said disk 1 is rotatably mounted on an eccentric 19, the eccentric 19 is carried by rotating input shaft 20 for rotation therewith.

It should be noted that gearings represented on the above described Figures can be used in two designs of transfers. The first design is a planetary transfer, in which one of disks is mounted on an eccentric of an input shaft (as it is shown in FIGS. 5 and 8). In the second design, disks 1 and 2 are both rotatbly mounted in the casing and their axes are offset from each other. The last transfer is similar to a usual tooth gearing with parallel shafts, only gearing occurs by means of balls. The two designs have the different transfer ratio, but both have greater load range and higher efficiency.

Now, pass to the description of units in which balls cooperate with periodic elements of three parts. In the three-part gearing, as a rule, a ball makes oscillatory moving relative to all three parts. It is essential that ball does not go beyond lands between slots during wave moving relative to a part having equiangularly spaced slots. The example of this gearing is shown in FIGS. 11 and 12. Herein, two disk parts 1 and 2 are provided with periodic grooves cut in faced each other surfaces of said disk parts. Said grooves are: periodic bent continuous groove 3 in the disk 1, and equiangularly spaced slots 25 in the disk 2. The third part of the gearing is disk 26 acting upon a ball 5 by a groove 27 in its side 28. The ball 5 contacts to groove 27 in the bottom region of the last. The groove 27 may be either of single-periodic, multiperiodic, or annular. In the last occurrence, disk 26 should make planetary movement. The periodic groove 3 in the disk 1 has only one sidewall 7; opposite sidewall is cut off so that the disk 26 being able installed. The sidewall 7 of the groove 3 is increased in height by h and so walls 29 of slots 25 are decreased in opposite area. Now, the contact area of a groove 3 with ball 5 (reference by A in FIG. 11) lays along of straight line agreeing with direction of yield force F. Accordingly, the walls of equiangularly spaced slots 25 which walls are opposite to cut off walls of the groove 3, are to be increased in height so that tangential force F₃ (FIG. 12) passing through a ball center did act to these walls normal to their surfaces. The increased walls of slots 25 form projections 30. At that, projections 30 are to have such axial thickness L in the area of ball moving that ball center did not go beyond limits of projections 30 during ball moving along slots 25. Therefore, surfaces of projections 30 faced to periodic groove 3 are convex and inscribable into surface of groove 3. Practically, the surface of the disk 1 faced to the disk 2 is composed of two steps 31 and 32 (FIG. 2). Similarly, the surface of the disk 2 is composed of two steps 33 and 34 mutually mating with steps 31 and 32 of the disk 1, accordingly.

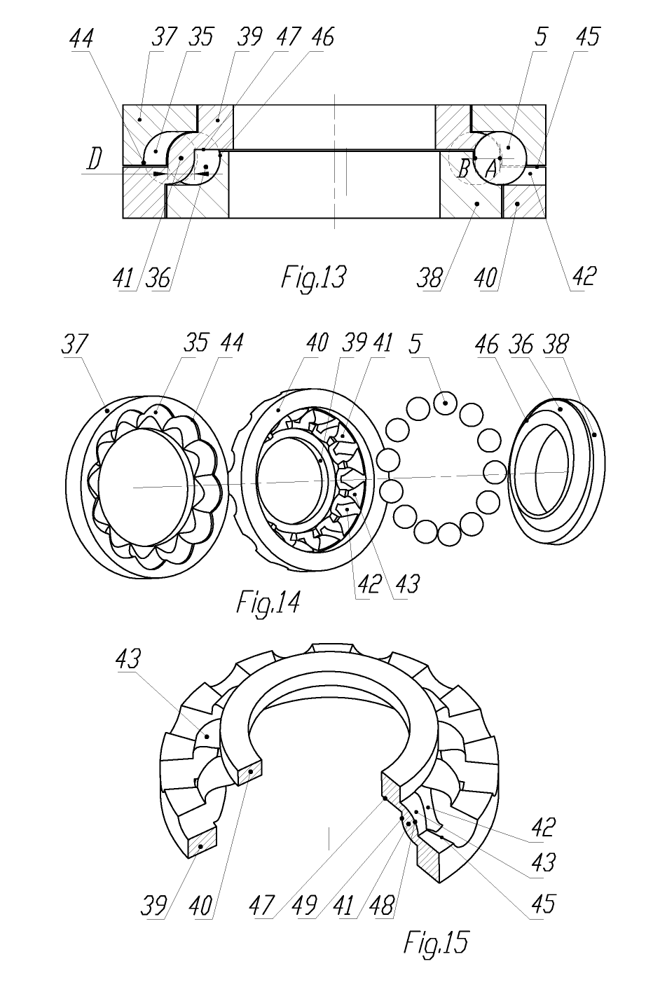

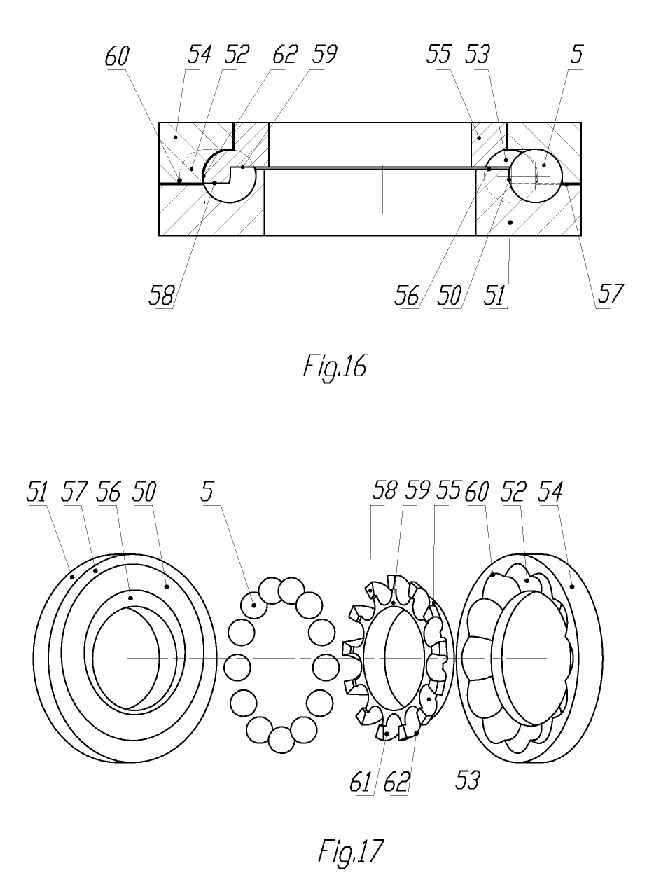

Refer now to FIGS. 13, 14, and 15 wherein is shown other embodiment of ball gearing in which closed periodic grooves 35 and 36 are cut in cages 37 and 38. Equiangularly spaced slots in the form of through slots are cut in a complex part composed of two cylinders 39, 40 of different diameters, which cylinders are connected by component 41 in which, properly speaking, said through slots 42 with bridges 43 are made. Height of a sidewall 44 of a groove 35 exceeds the ball radius, and height of sidewalls 45 of slots 42 is decreased in the area opposite to the sidewall 44. Another sidewall of the groove 35 is cut off. A sidewall 46 of a groove 35 also has a height exceeding a ball radius.

The sidewall 46 of the groove 36 also has the height exceeding the ball radius with the appropriate height decreasing of sidewalls 47 of slots 42 in opposite area. The second sidewall of the groove 36 is cut off. Sidewalls of slots 42 in the fields of the balls centers movement are made of the increased thickness and have the form of two opposite directed convexes 48 and 49 inscribable in surfaces of grooves 35 and 36 accordingly. As a result, the sidewalls thickness D of slots 42 is increased in a plane of an arrangement of the balls centers, and the center of a ball 5 (points A and B of FIG. 13) does not go beyond the limits of slots sidewalls during wave radial movements of a ball. Meeting of this condition provides acting of tangential pressure forces balls upon walls of slots in a normal direction to surfaces of said walls.

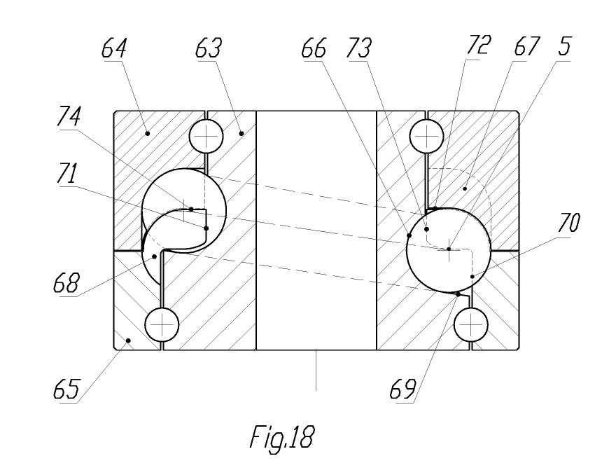

Referring to FIGS. 16 and 17, we consider one more embodiment of three-part ball engagement according to the invention. Here, one continuous groove 50 is in the flat surface of a disk 51. Another continuous periodic groove 52 and equiangularly spaced radial slots 53 are disposed in the intersection of planes of cages 54 and 55. Being made in appropriate steps 56 and 57 of surface disk 51 the internal sidewall of a groove 50 has increased height; the external side wall has decreased height, accordingly. Opposite thereto surface of cage 55 also is made stepped composed of steps 58 and 59 mating to steps 56 and 57 accordingly. As a result, sidewalls of slots 53 disposing in area of step 58 are increased in height, and sidewalls of the same slots in area of step 59 are decreased in height. To mate thereto, external sidewall 60 of a groove 52 in a cage 54, which sidewall is opposite to decreased sidewall of a groove 50 in the disk 51, is increased in height, and internal side wall of a groove 52 is cut off. To prevent the center of the ball 5 from going beyond limits of bridges 61 between radial slots 53, the external sides 62 of bridges 61 have convexes inscribable in the groove 52 surface of the cage 54.

Above, we considered the invention in application to flat ball gearing. However, all reasoning and requirements also are correct for cylindrical or spherical gearing in which grooves act balls by edges of their sidewalls. By “cylindrical gearing” in this case is named the gearing in which grooves are cut in side cylindrical surface of the parts having the form of cages. We shall consider for an example the cylindrical ball gearing shown in FIG. 18. The gearing consists of an embraced cage 63 and embracing cages 64 and 65. In an external cylindrical surface of the cage 63 a periodic groove 66 is cut. In this case it is an inclined groove. Periodic elements are cut in cages 64 and 65 in a place of joint cages in their internal cylindrical surfaces. Periodically bent in axial direction grooves 67 is cut in the cage 64, and axial equiangularly spaced slots 68 are cut in the cage 65. A side wall 69 of the groove 66 is increased in height to exceed a ball radius, with appropriate height decreasing sidewalls 70 of slots 68 in opposite area. Accordingly in other area 71 of said slots 68 their sidewalls are increased in heights. The groove 67 has a sidewall 72 increased in height, with appropriate height decreasing of opposite sidewall 73 of the inclined groove 66. To prevent ball from going beyond bridges between axial slots 68, their external surfaces 74 are made convex and inscribable in the surface of the groove 67.

It is necessary to note, that the scope of declared ball gearing is not limited by designs shown in figures. It is applicable in any gearing wherein torque is transferred by means of interacting balls and grooves forcing balls by an edge of their sidewall.

Operating of the device we show on an example of the engagement a ball with two periodic elements in the form of the closed cycloid grooves shown on [symbol] r 2, 3 and 4. Assuming that a disk 1 is driving member and it is brought in plane-parallel planetary movement having eccentricity relative to an immovable disk 2. A groove 3 has a number of periods which is more then numbers of balls 5 by 1, and a groove 4 has a number of periods which is less than number of balls by 1. A working wall of the groove 3 is the external wall 7 having higher angles of rise. Pressure of a wall 7 is transferred by ball 5 to a wall 8 of the groove 4. Interaction of a ball 5 and walls 7 and 8 results in turning of the disk 1 around of the immovable axis by angle depending on the numbers periods of both grooves 3 and 4 on disks 1 and 2. The additional mechanism is provided to absorb the revolution component and to transmit only the rotational component. Such mechanisms well-known and bear no relation to a subject of the invention. As the heights of counteracting walls 7 and 8 is increased and exceeding radius of a ball by h, the force of a ball 5 will be applied rather not to edges of these walls but to some area displaced from edges. And forces of pressure walls and balls to each other are directed along one straight line, and these forces have not an axial components pushing apart disks 1 and 2 from each other and increasing friction forces.

Operation of other embodiment ball gearing composed of the closed periodic groove and of dimples the various forms shown in FIGS. 5-10 differs from the above described gearing only in gear ratios. Rotation of an input shaft 20 with the eccentric section 19 causes plane-parallel planetary movement of a disk 1 with the closed periodic groove 3. Disk 2 is an immovable part. Ball 5 interaction with walls 11 of the groove 3 and with walls 14 of the dimples 10 causes turning of the disk 1 relative to the immovable disk 2. Since the disk 1 makes rotation around of own axis together with orbiting then an additional mechanism is necessary to absorb the revolution component and to transmit only the rotational component. (It is not shown). Due to the wall 11 of the groove 3 exceeds a ball radius; and the area 14 of the dimple 10 exceeds a ball radius, the distribution of the forces is improved between walls of periodic elements and a ball. There is not a force pushing apart said disks from each other, and this fact increases an efficiency of the ball gearing. Displacement from wall edge the interaction area of groove walls with a ball reduces wall deterioration, and increases service life.

Operation of the devices shown in FIGS. 8, 9, 10 wherein a ball 5 sits in hemispherical dimple 22 and engages closed periodic groove 3, is similar to the operation of the above described gearing except that the ball only rotates in hemispherical dimples during operating. All other previous reasoning is fair for this device.

In operation of a ball gearing wherein periodic elements in the form of periodic closed grooves and radial equiangularly spaced slots are cut in three interacting parts which is shown in FIGS. 11 and 12. Floating annulus 26 forces balls 5 by bottom of its groove 27. Disk 1 is a reaction immovable part having a groove 3. Balls 5 movement along of radial slots 25 and orbital moving caused by their interaction with the sidewall 7 of immovable periodic groove 3, both result in turning of the disk 2 with radial slots 25, relative to disk 1. Herewith, any ball in radial slot runs in range marked by points A and B, and in that range height of walls 30 exceeds a ball radius. Thus, a force F acting upon ball from floating annulus 26, and a force N acting upon a ball from a sidewall 7 of a groove 3, both act not to the edge of the groove. Under the action of both these forces, the ball is displaced along the walls of the continuous groove 3 in an azimuth direction while pressing walls of the radial slot by force F₃ (FIG. 3) thereby driving in movement the disk 2 relative to the disk 1. It is seen from FIG. 12 that the ball acts upon projection 30 of bridge between slots 25, a height of which projection 30 exceeds a ball radios. Thus, the interaction ball with all three grooves occurs at some depth from its edges rather then acting at its edges thereby reducing destruction probabilities of grooves due to wear. All forces of the interaction make useful work and they have no components for increasing friction force or components for pushing disks 1 and 2 apart each other.

The operation of others embodiments of the three-part units with ball engagement (FIGS. 13-17) is similar to above. In all these units the working area of grooves walls has the increased height with appropriate decreasing height of opposite inoperative wall areas of other driving parts.

Operation of cylindrical three-parts gearing shown in FIG. 18 is similar to above. Rotation of a cage 63 with inclined groove 66 causes ball 5 to move in axial direction. In this moving the ball simultaneously interacts with continuous periodic groove 67 of a cage 64 and with axial slot 68 of a cage 65. In one of said cages 64 and 65 is immovable, the other cage rotates by angle determined by number of periods the groove 3. The ball practically always is space confined by walls of increased height; and forces of interaction ball with walls of grooves have only axial and tangential components (for axial slots), which forces make useful work. Herein, efficiency of a ball gearing and its reliability are increased, as well as in embodiments above described.

1. Ball gearing for rotation transfer comprising:
at least, three parts provided with periodic elements on the surfaces thereof faced each other,
a chain of balls simultaneously engaging the periodic elements of all said parts,
wherein the integrated amplitude of the periodic elements of an interacting parts is equal to or less than the ball diameter,
said ball gearing is characterized in that the part surfaces which are provided with said periodic elements, faced each other and act on the ball by sidewalls thereof, are mutually stepwisely interfaced to each other,
said periodic elements are embodied in said mutually stepped surfaces and are conjugate each other in such a way that the height of the sidewall of each periodic element is increased in an area and is greater than the ball radius by reducing the height of the periodic element sidewalls on the area opposite thereto of the other parts.
